(19) United States
(12) Patent Application Publication
(10) Pub. No.: US 2018/0181891 A1
(43) Pub. Date: Jun. 28, 2018

(54) MEASURE INPUT CONTROL

(71) Applicant: SAP SE, Walldorf (DE)

(72) Inventors: Edwin Nathaniel, Burnaby (CA); Philip Lau, Richmond (CA); Brandon J. White, Pitt Meadows (CA)

(21) Appl. No.: 15/389,739

(22) Filed: Dec. 23, 2016

(51) Int. Cl. G06Q 10/06

(52) U.S. Cl. CPC G06Q 10/0637; G06Q 10/0639

(57) ABSTRACT

A system, method, and computer-readable medium, to receive, by a content consumer from a content creator, an indication of a visualization published by the content creator, the visualization being defined by a listing of at least one measure of a data set at the time of creation of the visualization; invoke, at a request of the content consumer, a use of the visualization; update, in reply to the invocation of the visualization and exclusive of the content creator, the visualization to include a current listing of at least one measure defining the visualization at the time of the invocation of the visualization; and use the updated visualization in reply to the request of the content consumer.

### BACKGROUND

Enterprise software systems receive, generate, and store data related to many aspects of an enterprise. Reporting tools may access the data and present the data in a variety of graphic visualizations, including different types and formats of graphs. The visualizations might be used by consumers thereof to gain insights into the operations of the enterprise and/or other purposes.

The data may be represented by different data structures (e.g., objects) that may be classified as measures (e.g., revenue, taxes) having values that can be used in calculations, and dimensions (e.g., year, country) defining categories into which the measures can be filtered, grouped, and labeled for analysis and reporting.

Content creators may define visualizations to include presentations of values of one or more measures of the enterprise's data where the created visualizations may subsequently be consumed by one or more content consumers. Conventionally, content creators create visualizations based on the measures available in a data set at the time the visualization is created. The measures are those available at a specific point in time and constitute a static list or set of measures. The visualizations created by the content creator are then published so that content consumers can use them.

Conventional reporting tools provide many types of visualizations for graphically presenting values of one or more measures. However, more efficient and flexible systems and methods are desired to generate visualizations.

### BRIEF DESCRIPTION OF THE DRAWINGS

FIG. 1 is an example process to create visualizations;

FIG. 2 is an example visualization;

FIG. 3 is an example of a collaboration diagram relating to a process herein;

FIG. 4 is an example flow diagram of a process;

FIG. 5 is an example of an input control herein;

FIG. 6 is an example flow diagram of a process herein;

FIG. 7 is an example block diagram of a system architecture; and

FIG. 8 is a block diagram of an apparatus, according to some embodiments.

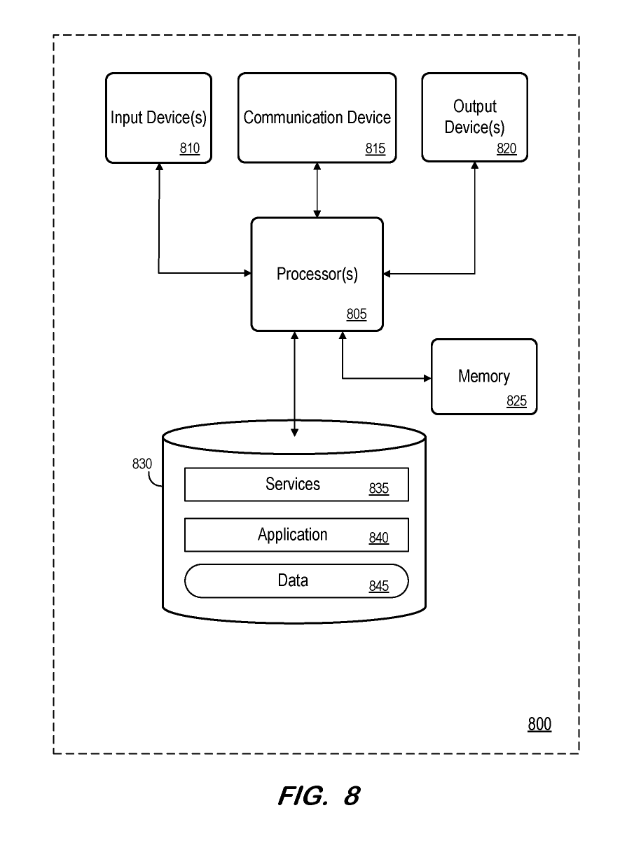

### DETAILED DESCRIPTION

The following description is provided to enable any person in the art to make and use the described embodiments. Various modifications, however, will remain readily apparent to those in the art.

In some example contexts, use-cases, and embodiments, one or more terms will be used in the present disclosure. As a matter of introduction and to ease the understanding of the present disclosure, a number of terms will be introduced, where the full meaning of the following terms will be further understood in context of the disclosure herein, on the whole.

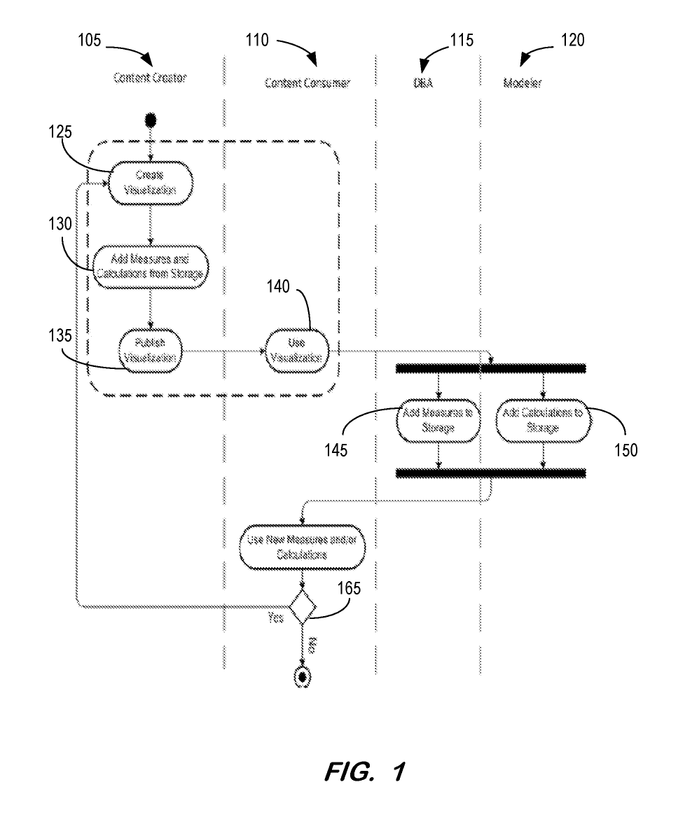

FIG. 1 is an illustrative depiction of a process used to create a visualization, in some conventional scenarios. The process shown in FIG. 1 includes a number of interactions between different entities, including a content creator 105 that creates visualizations, a content consumer 110 that uses or otherwise consumes the visualizations created by content creator 105, a database administrator (i.e., DBA) 115 that might add measures to a data store, and a modeler 120 that might edit data models in the data store. In some aspects, calculations can be created by a content creator without the need of a DBA. A measure input control (MIC) herein may also be considered as a measure herein. It is, in some respects, a measure that can refer to other measures (wrapper/facades).

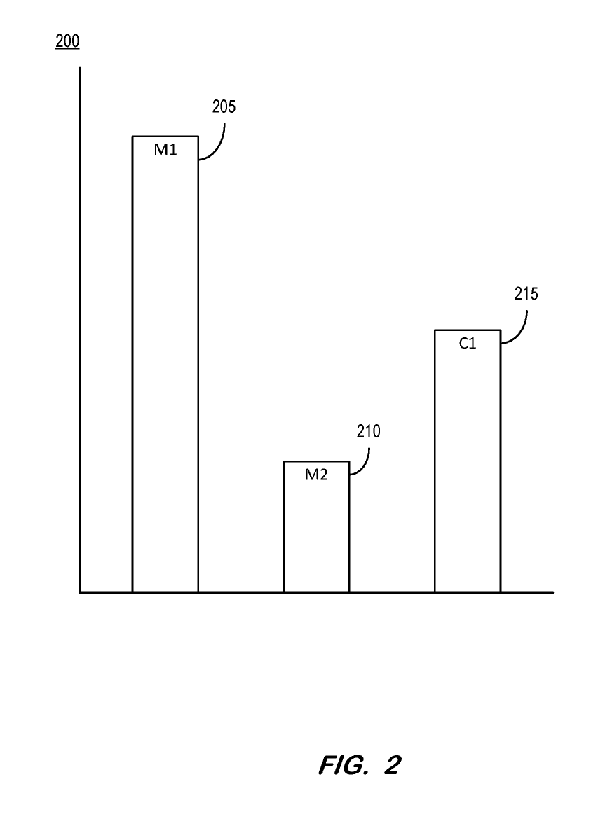

In some contexts and scenarios, content creator 105 creates, at a specific point in time, a visualization at 125 based on a set of data (i.e., a data set) classified in measures and dimensions. Content creator 105 creates the visualizations by, in part, adding one or more measures of the data set to a data structure representation of the visualization being created at 130. The visualizations may further be defined and include one or more calculations, where a calculation is typically a computation based on one or more of the measures of the data set. For example, a first calculation (c1) may be the result of a computation including a first measure (m1) and a second measure (m2) such as, c1=m2−m1. A visualization 200 based on the inputs of m1, m2, and c1 might include a bar chart with graphic bars representing m1 (205), m2 (210), and c1 (215), as shown in FIG. 2. The measures and calculations added to the visualization being created in the example of FIG. 1 are selected from those measures and calculations available in a storage at the time the visualization is created. That is, the measures and calculations added to the visualization at 130 are those available at a “snapshot” in time.

At 135, the content creator publishes the created visualization so that it can be accessed and subsequently used by a content consumer at 140.

At some time 145, 150 after the creation and publication of the visualization, additional (i.e., new) measures (e.g., m3, m4) and calculations (e.g., c2) may be added to the storage containing the data set associated with or referenced by the visualization created, defined and published at 125-135, respectively. If content consumer 110 wants to have a visualization that includes/uses the newly added measure(s) and calculation(s), as determined at 165, then the process of FIG. 1 returns to 125 to create a new visualization by the content creator that can include the measure(s) and calculation(s) added to the storage after the creation of the visualization. In creating the new visualization, content creator 105 may select one or more of the newly added measures and calculations from the storage to add to the new visualization.

FIG. 1 illustrates a process wherein the measures and calculations used in a visualization are statically set and defined by a content creator at the time the visualization is created. After a visualization is published in the process of FIG. 1, newly added measures and/or calculations cannot be added to the visualization. Modification of a visualization to add or otherwise include the newly added measures and/or calculations to the previously created and published visualization requires the content creator to create and publish a new visualization based on the measures and/or calculations currently available to the content creator.

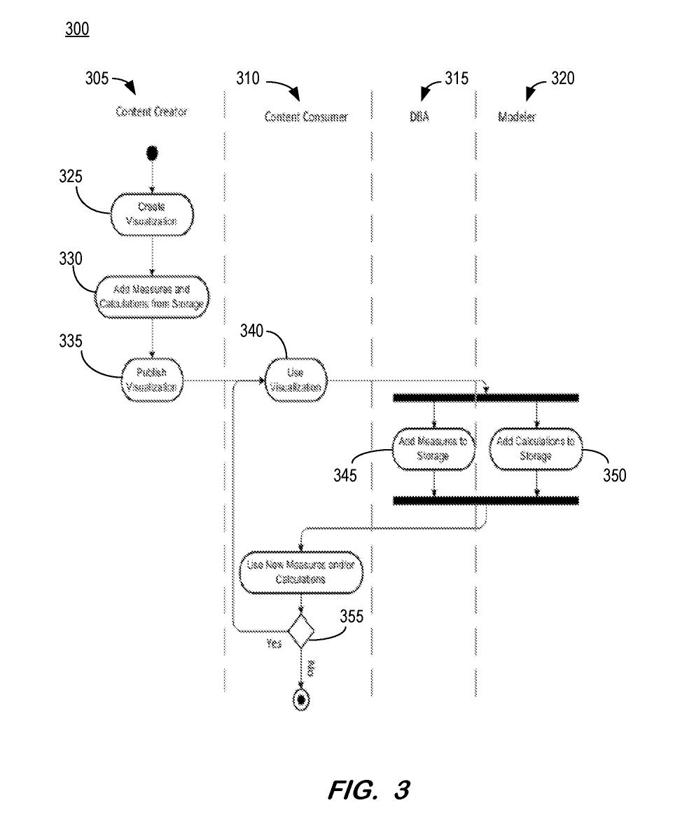

FIG. 3 is an illustrative example of a collaboration diagram 300, in accordance with some embodiments herein. FIG. 3 Diagram 300 illustrates interactions between a content creator 305, a content consumer 310, a database administrator 315, and a data modeler 320. Content creator 305, with respect to the present example, initiates a visualization creation process at 325. The visualization process includes the content creator adding at least one measure to a data structure representation of a visualization to create, at a specific point in time 330, a visualization based on a set of data (i.e., a data set) that classifies the data in measures and dimensions. In some aspects, the one or more measures added at 330 may include calculations based on one or more measures of the data set accessed, referenced, and used in creating the visualization of the present example. The measures and calculations added at 330 (e.g., m1, m2, and c1) may be selected from the measures and calculations (m1, m2, m3, m4, c1, c2) in a data store storing the data set at the time the visualization is created (i.e., at time of 330). FIG. 3 further shows that the content creator publishes the created visualization at 335 so that the visualization can be accessed and subsequently used (i.e., consumed) by a content consumer at 340.

FIG. 3 further illustrates the addition of at least one of a measure and a calculation to the storage of the data set at 345 and 350, respectively, after the visualization is created, defined, and published at 325-335. In this manner, the data set at the times of 345 and 350 is different than it was at the time 330 when the visualization was initially created in the example of FIG. 3. In some aspects, the storage may be continually or periodically updated as the measures and calculations related to a data set changes.

At 355, a determination is made by content consumer 310 whether the measures and calculations newly added at 345 and 350 are to be used in the previously created visualization. For example, if the content consumer would like to include the newly added measures and calculations in a previously created visualization in an effort to, for example, see an accurate and complete view of the current (i.e., updated) state of the data, then the present disclosure includes a mechanism for the content consumer to use the newly added measures and calculations in previously created visualizations. This aspect is illustrated in FIG. 3 by the arrow from 355 to 340 indicating the new measures and calculations added at 345 and 350 are used at 340. As shown in FIG. 3, the new measures and calculations can be used in a previously created visualization at 340, without intervention or further interaction from or by content creator 305.

Upon returning to 340, process 300 of FIG. 3 may continue as previously described, where new measures and calculations may be added to the data store of the data set at 345 and 350 and those new measurements and calculations may be considered, by the content consumer, for use in a previously created visualization.

In the event that content consumer 310 does not want to use the measures and calculations newly added to the data set's storage at 345 and 350, then no further action is performed with respect to the example of FIG. 3.

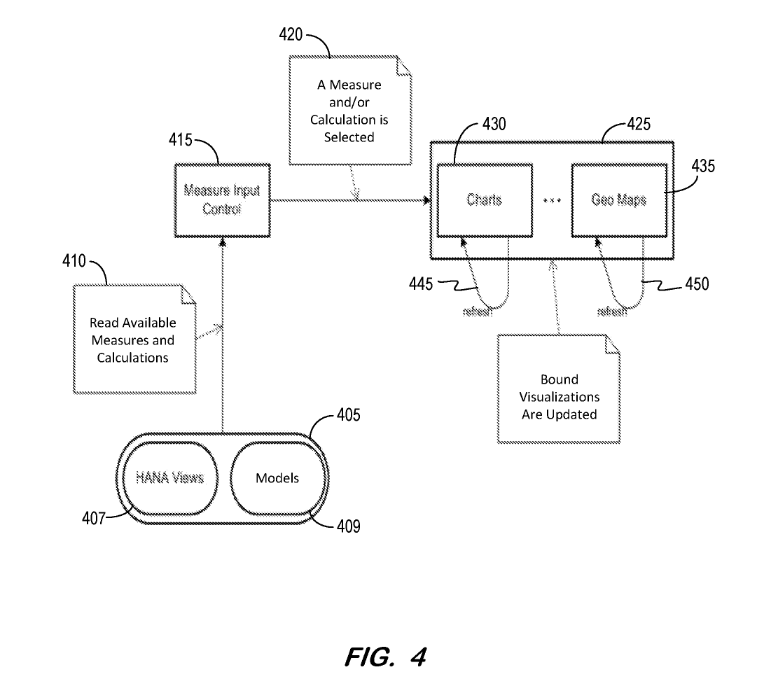

FIG. 4 is an illustrative depiction of some aspects of an input control herein. In particular, FIG. 4 illustrates some aspects of an input control mechanism (e.g., a data structure) that can be created to control or govern the inputs of a visualization. In some embodiments, an input control herein may be referred to as a measure input control (MIC) or simply an input control. An input control herein may concern the use of both measures and calculations in some embodiments, and the term measure input control is used herein to also refer to such input controls.

Referring to FIG. 4, a storage (i.e., data store) is shown at 405. Storage 405 may store measures and calculations based on or derived from measures. As an example, storage 405 may include HANA Views 407 including measures of a database and BusinessObjects Cloud (BOC) Models 409 from which calculations for the data set can be obtained. However, other forms and representations of measures and calculations may be included in storage 405. In some embodiments, the measures and calculations in storage 405 may be from the same or different sources or entities.

Continuing with FIG. 4, a content creator reads or otherwise receives an indication of the measures and calculations available in storage 405 at 410. The content creator uses the available measures and calculations to create and generate (i.e., generate) a measure input control (MIC) 415. In some embodiments herein, MIC 415 can include a dynamic listing of measures and calculations in the storage selected from the available measures and calculations stored in the storage 405.

According to FIG. 4 and the MIC 415 created therein by the content creator, the content creator selects or otherwise indicates at 420 one or more of the available measures and calculations that may be used in the future by a content consumer in a visualization.

Having created the MIC and selected or otherwise designated the measures and calculations to be included in MIC 415, the content creator further associates or binds MIC 415 to at least one visualization 425. Visualization 425 may comprise one or more graphic visualizations of the same or different type(s). Visualization 425 may include charts 430, geo maps 435, and other visualizations not specifically shown in FIG. 4 (e.g., graphs of different types, etc.). The bound visualization, in accordance with some embodiments herein, is updated when the content consumer makes a new selection in the MIC 415 as indicated at 445 and 450. Updating of the visualization 425 may include refreshing the charts 430 and geo maps 435 to use the newly added measures and calculations in response to the MIC 415 being bound to the visualization 425 and the storage 405 being updated with the newly added measures and calculations. In operation, measures and calculations selected in a MIC are reflected in the visualizations bound to the MIC. Accordingly, in some embodiments, changes to a data storage that are reflected in a MIC are propagated to the visualizations bound to the MIC.

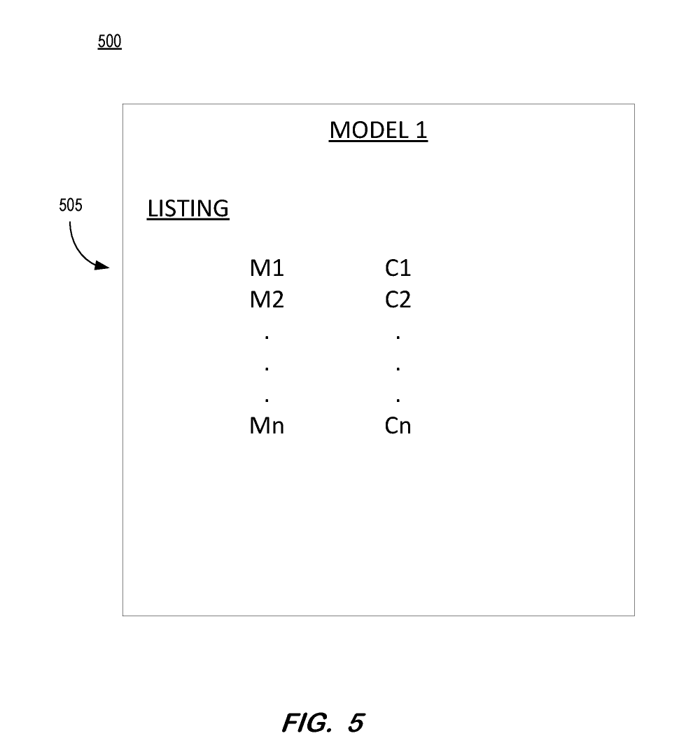

FIG. 5 is an illustrative depiction of a MIC, generally shown at reference 500. As shown, MIC 500 includes a dynamic listing 505 of available measures and calculations selected from a storage device. The listing is referred to as being dynamic since, in some aspects, the listing 505 may be updated or refreshed as the measures and calculations in a storage for a data set (e.g., storage 405 in FIG. 4) are changed (e.g., measures and calculations are added, deleted, and modified). In some embodiments, the listing of measures and calculations in a MIC may be updated automatically as the storage is changed or updated. In some embodiments, including a MIC having hierarchical measures where new child measures and calculations (e.g., formulas, etc.) are created after or subsequent to the selection and inclusion of the parent measure or calculation in the MIC, the new child measures and calculations can be automatically and immediately included in the MIC for selection by a content consumer.

For example, a consumer might refresh a browser on one of their mobile computing devices. The refreshing of the browser may invoke a call to (re-)render one or more visualizations (e.g., a chart) on a display of the mobile computing device. In the event that the dynamic list of measures and calculations of a MIC associated with the visualization(s) to be rendered has changed since the last rendering of the visualization, then the refreshing of the browser may also cause the rendering of the MIC to include the new measures and calculations. In some regards, the dynamic list may be “fresh” when a content consumer opens content (i.e., a visualization) associated with the input control.

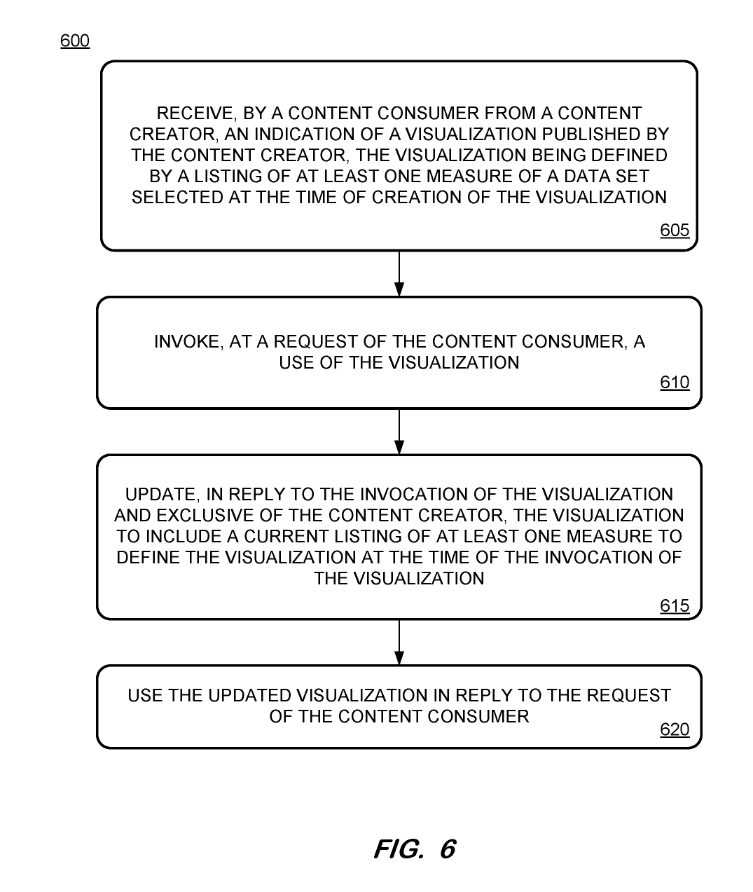

FIG. 6 is an example flow diagram of a process 600 in some embodiments herein. In some regards, FIG. 6 relates to a process to manage or control inputs of a visualization in an efficient manner. At operation 605, a content consumer may receive an indication of a visualization published by a content creator. Prior to operation 605, the content creator may create the visualization. Creation of the visualization by the content creator may include the content creator defining the visualization to include at least one measure of a data set selected at the time of creation of the visualization. In some embodiments, the at least one measure may be represented in a listing of measures selected from the data set at the time the visualization was created.

At operation 610, the content consumer may invoke a use or otherwise consumption of the visualization. The visualization might be included in an analysis and reporting thereof in an effort to, for example, better understand the operations of a relevant enterprise or organization related to the data (i.e., measures and calculations).

In reply to operation 610, operation 615 may proceed to update the visualization to include a current listing of at least one measure to define the visualization at the time of the invocation of the visualization. That is, operation 615 may operate to update the visualization to be consumed (as invoked at operation 610) with the new measures, if any, that may have been added to the data set associated with the visualization subsequent to the creation of the visualization (prior to operation 605) and up until the time of operation 610.

In accordance with other aspects herein, an input control may also be created by the content creator, at the time the visualization is created, that specifies the at least one measure selected from the data storage to include in the listing of the at least one measure. The content creator may further specify that the visualization is bound to the input control.

At operation 620, after the visualization has been updated to include any additional, different, or changed measures, the updated visualization may be used or consumed in reply to the content consumer's earlier request. In this manner, process 600 may provide a mechanism whereby a content consumer can be assured to have a current version or extent of data included in visualizations without the content creator having to re-create previously generated visualizations in order to have the updated data reflected in a current rendering of the visualizations.

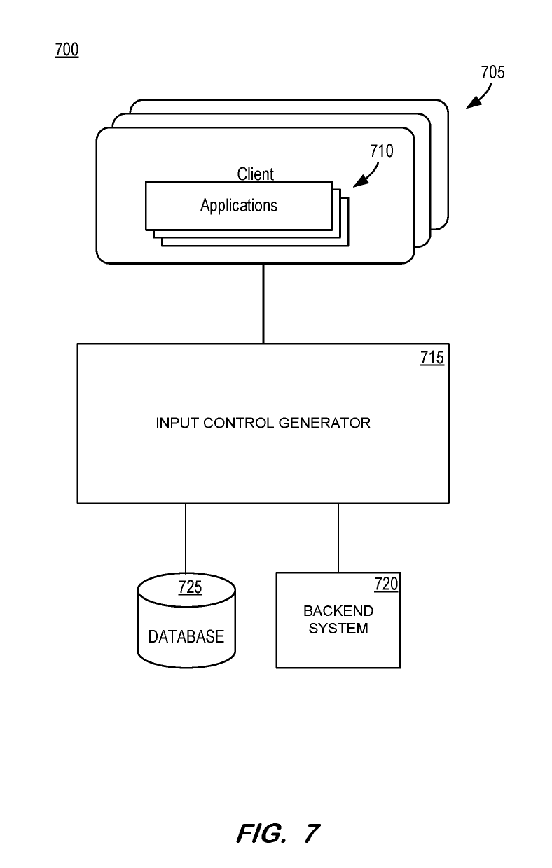

FIG. 7 is an illustrative block diagram of an architecture or system 700, in one example. Examples of some embodiments of the present disclosure are not limited to the particular architecture 700 shown in FIG. 7. System 700 includes one or more client devices 705 running one or more applications 710. Applications 710 may, in some embodiments, include a suite of different software applications having, at least to some extent, related functionality, similar user interfaces, and some ability to exchange data with each other. Applications 710 may include different software applications that support the operations and process of an organization. In some embodiments, one of the applications 710 may include functionality or a tool to define and create measure input controls that can be bound to (i.e., associated with) one or more visualizations to define and control the input of those visualizations. In some embodiments, applications 710 may be configured to facilitate, support, and execute a program to specify both graphic visualizations (also referred to herein as charts and simply, visualizations) and measure input controls (MICs). The measure input controls created and processed herein may be implemented by a data structure. The data structure may be stored in a persistent memory, where it can be accessed for a future use, including being bound to one or more visualizations in the context of a story and used to generate the visualizations bound thereto as directed by a content consumer. As used herein, a story refers to a collection, set, or other associated grouping of one or more visualizations that may share one or more characteristics or relationships (e.g., the multiple visualizations may each relate to a common organization, the multiple visualizations may each reference a common database, etc.). The functionality or tool that may be implemented by one of applications 710 may be device agnostic, working across different devices and technologies.

System 700 includes an input control generator service or server 715. In some embodiments, a functionality or service for creating and editing of input controls may be deployed as a cloud-based service, whereas in some other embodiments system 700 may include a client-server architecture. System 700 may encompass both scenarios. In the instance system 700 includes a server at 715, the devices at 705 may be client devices running applications as discussed above. In an instance system includes a cloud-based server at 715, the devices at 705 may execute a browser that is used by a user to interface with service 715.

System 700 further includes a backend system that can generate, automatically, executable code or instructions to perform a process to facilitate and support the creation input controls and visualizations. In some aspects herein, a user may provide an indication of the measures and calculations to be accessed by a content consumer, as implemented in an application 710 and/or server or service 715, which may operate in cooperation with the processing of a backend system 720 to generate a program to effectuate the input control generation that may be used in the use of visualizations. In some aspects, a Modeler (or a Content Creator as well if the user has Modeler role/authorization) will typically navigate to a “Modeler” view to model data of a Model/Dataset that can come from one or more different data sources (e.g., a file stored in the user's local computer, file(s) from a BOC database, file(s) from remote systems that could be backed by other databases, etc.). The Modeler will model the Dimensions and Measures for BOC specifically before a Content Creator can use them to build visualizations. In one example, a client 705 executes an application 710 to present an input control generator via a user interface (UI) to a user (e.g., Content Creator) on a display of client 705. The user manipulates UI elements within the UI to indicate and specify measures and calculations of an input control to be defined, where a server or service 715 embodying the input control generator operates. The Measure Input Control (MIC) is created in the browser and stored in the back-end. The logic itself is executed by the browser/client-side code. When the Content Creator/Consumer selects a measure defined in the MIC, the client-side will request the back-end for that specific measure (i.e., a control to select measures). In some respects, FIG. 7 and input control generator 715 in particular refers to an input control creation/capability, regardless of the platform behind it (whether it is client-side on a browser or native to a mobile application).

Data store 725 may comprise any data source or sources that are or become known. Data store 725 may comprise a relational database, a HTML document, an eXtensible Markup Language (XML) document, or any other data storage system storing structured and/or unstructured data files. The data of data store 725 may be distributed among several data sources. Embodiments are not limited to any number or types of data sources.

Data store 725 may implement an “in-memory” database, where a full database is stored in volatile (e.g., non-disk-based) memory (e.g., Random Access Memory). The full database may be persisted in and/or backed up to fixed disks (not shown). Embodiments herein are not limited to an in-memory implementation. For example, data may be stored in Random Access Memory (e.g., cache memory for storing recently-used data) and other forms of solid state memory and/or one or more fixed disks (e.g., persistent memory for storing their respective portions of the full database).

Apparatus 800 includes processor 805 operatively coupled to communication device 820, data storage device 830, one or more input devices 810, one or more output devices 820 and memory 825. Communication device 815 may facilitate communication with external devices, such as a reporting client, or a data storage device. Input device(s) 810 may comprise, for example, a keyboard, a keypad, a mouse or other pointing device, a microphone, knob or a switch, an infra-red (IR) port, a docking station, and/or a touch screen. Input device(s) 810 may be used, for example, to enter information into apparatus 800. Output device(s) 820 may comprise, for example, a display (e.g., a display screen) a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 825 may comprise Random Access Memory (RAM), Storage Class Memory (SCM) or any other fast-access memory.

Services 835 and application 840 may comprise program code executed by processor 805 to cause apparatus 800 to perform any one or more of the processes described herein (e.g., FIGS. 3, 4, and 6). Embodiments are not limited to execution of these processes by a single apparatus.

Data 845 (either cached or a full database) may be stored in volatile memory such as memory 825. Data storage device 830 may also store data and other program code and instructions for providing additional functionality and/or which are necessary for operation of apparatus 800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable instructions; and
a processor to execute the processor-executable instructions to cause the system to:
receive, by a content consumer from a content creator, an indication of a visualization published by the content creator, the visualization being defined by a listing of at least one measure of a data set selected at the time of creation of the visualization;
invoke, at a request of the content consumer, a use of the visualization;
update, in reply to the invocation of the visualization and exclusive of the content creator, the visualization to include a current listing of at least one measure to define the visualization at the time of the invocation of the visualization; and
use the updated visualization in reply to the request of the content consumer.

2. The system of claim 1, wherein the at least one measure comprises at least one calculation derived from a measure of the data set.

3. The system of claim 2, wherein the at least one measure comprises a combination of the at least one measure of the data set and the at least one calculation derived from a measure of the data set.

4. The system of claim 1, wherein the content creator defines an input control, the input control being a data structure that specifies the at least one measure included in the listing of the at least one measure of the data set at the time of creation of the visualization.

5. The system of claim 4, wherein the content creator selects the at least one measure included in the listing of the at least one measure of the data set from a data store including the data set at the time of creation of the visualization.

6. The system of claim 4, wherein the content creator specifies the visualization is bound to the input control.

7. The system of claim 6, wherein a single input control is bound to a plurality of different visualizations, multiple input controls are bound to a single visualization, and combinations thereof.

8. The system of claim 1, wherein the input control is associated with a story, the story being a related set of visualizations.

9. The system of claim 1, wherein the visualization is further defined by at least one of a measure and a calculation derived from the at least one measure of the listing selected at the time of creation of the visualization, wherein the at least one of a measure and a calculation derived from the at least one measure of the listing selected at the time of creation of the visualization is included in the update of the visualization.

10. A non-transitory computer-readable medium storing program instructions executable by a processor of a computing system, the medium comprising:
instructions to receive, by a content consumer from a content creator, an indication of a visualization published by the content creator, the visualization being defined by a listing of at least one measure of a data set selected at the time of creation of the visualization;
instructions to invoke, at a request of the content consumer, a use of the visualization;
instructions to update, in reply to the invocation of the visualization and exclusive of the content creator, the visualization to include a current listing of at least one measure to define the visualization at the time of the invocation of the visualization; and
instructions to use the updated visualization in reply to the request of the content consumer.

11. The medium of claim 10, wherein the at least one measure comprises at least one calculation derived from a measure of the data set.

12. The medium of claim 11, wherein the at least one measure comprises a combination of the at least one measure of the data set and the at least one calculation derived from a measure of the data set.

13. The medium of claim 10, wherein the content creator defines an input control, the input control being a data structure that specifies the at least one measure included in the listing of the at least one measure of the data set at the time of creation of the visualization.

14. The medium of claim 13, wherein the content creator selects the at least one measure included in the listing of the at least one measure of the data set from a data store including the data set at the time of creation of the visualization.

15. The medium of claim 13, wherein the content creator specifies the visualization is bound to the input control.

16. The medium of claim 15, wherein a single input control is bound to a plurality of different visualizations, multiple input controls are bound to a single visualization, and combinations thereof.

17. The medium of claim 10, wherein the input control is associated with a story, the story being a related set of visualizations.

18. The medium of claim 10, wherein the visualization is further defined by at least one of a measure and a calculation derived from the at least one measure of the listing selected at the time of creation of the visualization, wherein the at least one of a measure and a calculation derived from the at least one measure of the listing selected at the time of creation of the visualization is included in the update of the visualization.

19. A method comprising:
receiving, by a content consumer from a content creator, an indication of a visualization published by a processor for the content creator, the visualization being defined by a listing of at least one measure of a data set selected at the time of creation of the visualization;
invoking, via the processor at a request of the content consumer, a use of the visualization;
updating, by the processor in reply to the invocation of the visualization and exclusive of the content creator, the visualization to include a current listing of at least one measure to define the visualization at the time of the invocation of the visualization; and
using, by the processor, the updated visualization in reply to the request of the content consumer.

20. The method of claim 19, wherein:
the content creator defines an input control, the input control being a data structure that specifies the at least one measure included in the listing of the at least one measure of the data set at the time of creation of the visualization; and
the content creator selects the at least one measure included in the listing of the at least one measure of the data set from a data store including the data set at the time of creation of the visualization.
